(19) United States
(12) Patent Application Publication
(10) Pub. No.: US 2018/0272515 A1
(43) Pub. Date: Sep. 27, 2018

(54) MULTIFUNCTIONAL PLIER

(71) Applicant: FENG SUN, Yangjiang (CN)

(72) Inventor: FENG SUN, Yangjiang (CN)

(21) Appl. No.: 15/642,215

(22) Filed: Jul. 5, 2017

(30) Foreign Application Priority Data
Mar. 27, 2017 (CN) 201720303994.3

(51) Int. Cl. B25F 1/00; B25F 1/04; B26B 11/00; B25B 7/22

(52) U.S. Cl. CPC B25F 1/003; B25F 1/04; B26B 11/003; B26B 11/001; B25B 7/22; B26B 11/005

(57) ABSTRACT

A multifunctional plier may include a first plier unit with a first handle portion, and a second plier unit with a second handle portion. The first handle portion has a rivet at a rear end of the first handle portion to rivetedly connect a first blade and a second blade, which can be received in a receiving space. A third handle portion that drives the second blade to cut is hinged to the non-cutting end of the second blade. It is noted that the third handle portion can rotate toward the second blade to be folded at an opening of the receiving space. The receiving space is large enough to receive the first blade and second blade, so the size of the blade and handle can be increased to endure a larger force and be able to cut a harder and larger object.

### FIELD OF THE INVENTION

The present invention relates to pliers, and more particularly to multifunctional pliers.

### BACKGROUND OF THE INVENTION

Currently, most multifunctional pliers on the market are disadvantageous due to limited size of the handle. So, they can be used to receive blades with smaller volume that cannot endure relatively large force, which means that these blades are suitable only for cutting paper and relatively soft objects. Therefore, there remains a need for a new and improved design for a multifunctional plier to overcome the problems stated above.

### SUMMARY OF THE INVENTION

In one aspect, a multifunctional plier may include a first plier unit with a first handle portion, and a second plier unit with a second handle portion. The first plier unit and second plier unit are coupled with a hinge above the first and second handle portions.

In one embodiment, the first handle portion has a rivet at a rear end of the first handle portion to rivetedly connect a first blade and a second blade. When first handle portion is folded in a counterclockwise manner toward the first plier unit, a first receiving space can be seen from the second plier unit, and can be used to receive the first blade and second blade. The first blade and second blade can rotate around the rivet to be unfolded out from the receiving space. A third handle portion that drives the second blade to cut is hinged to the non-cutting end of the second blade. It is noted that the third handle portion can rotate toward the second blade to be folded at an opening of the receiving space.

The first handle portion has a restricting unit and a spring on the opposite side of the receiving space. In one embodiment, the restricting unit is in contact with a stopping edge of the first blade when the first blade 6 rotates to an angle of 180° against the first handle portion to prevent the first blade from further rotating. Without the restricting unit to block the rotation movement of the first blade, the rotating angle of the first blade cannot be limited, and a cutting action cannot be completed with the first blade and second blade.

The second blade has a pressing position of the spring, which can be pressed when second blade rotates to the first blade for cutting. Comparing with a conventional structure with an inner spring when two blades are hinged, this structure can simplify the assembly process of the two blades and reduce the thickness of the blades.

A plurality of small tools can be included within the first handle portion and second handle portion, riveted to a rear end of each first and second handle portions. In one embodiment, small tools riveted to the rear end of first handle portion may include a blade, a nail puller, a can opener, a rope cutter and a screwdriver. In another embodiment, small tools riveted to the rear end of second handle portion may include a saw blade, a file, and a glass knocker.

### BRIEF DESCRIPTION OF THE DRAWINGS

FIG. 1 is a schematic view of a multifunctional plier in the present invention.

FIG. 2 is a schematic view of the first blade and second blade of the multifunctional plier in the present invention.

FIG. 3 is a schematic view of the third handle portion of the multifunctional plier in the present invention.

FIG. 4 is a schematic view of the multifunctional plier in the present invention when it is folded.

FIG. 5 is a schematic view of the restricting unit and spring of the multifunctional plier in the present invention.

FIG. 6 is a schematic view of the second blade and spring of the multifunctional plier in the present invention.

FIG. 7 is a schematic view of the small tools in the multifunctional plier in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In order to further understand the goal, characteristics and effect of the present invention, a number of embodiments along with the drawings are illustrated as following:

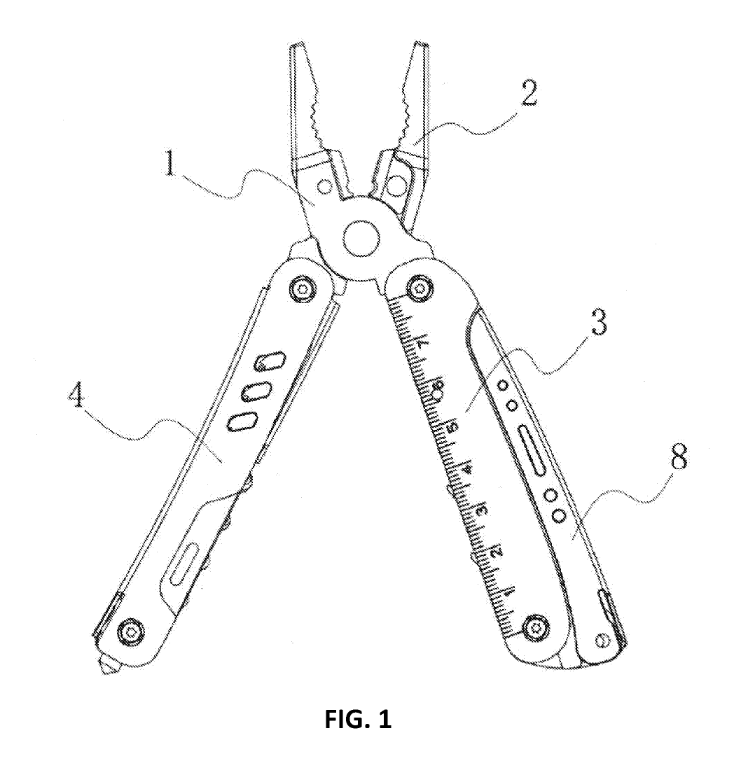

In one aspect, a multifunctional plier may include a first plier unit 1 with a first handle portion 3, and a second plier unit 2 with a second handle portion 4. The first plier unit 1 and second plier unit 2 are coupled with a hinge above the first and second handle portions as shown in FIG. 1.

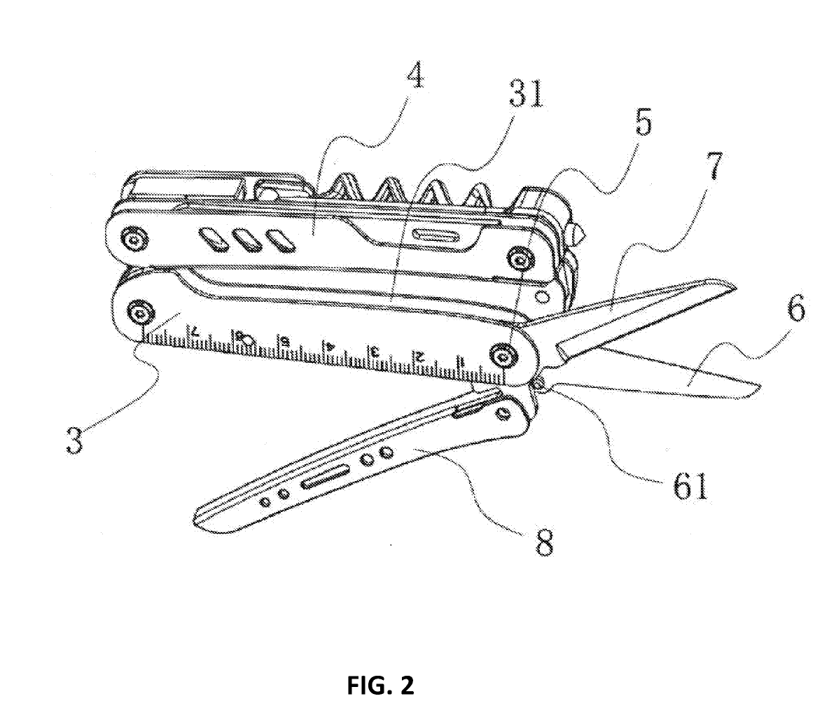

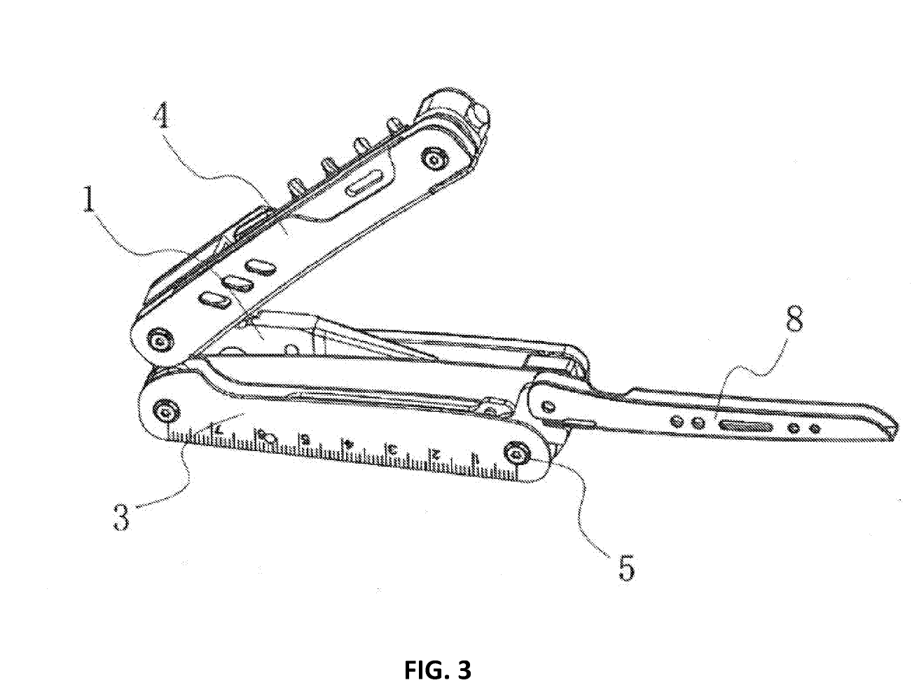

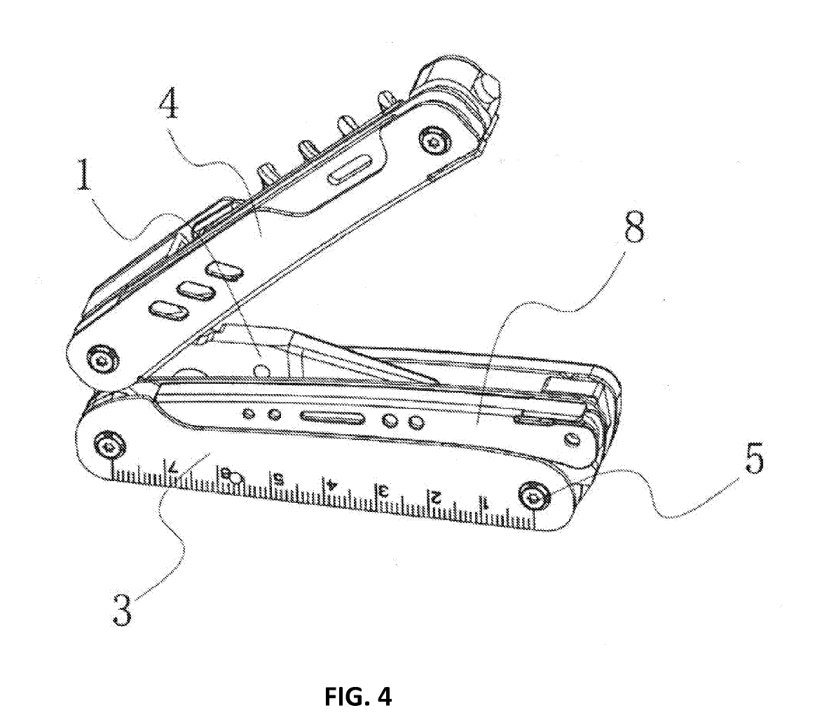

In one embodiment, as shown in FIG. 2, the first handle portion 3 has a rivet 5 at a rear end of the first handle portion 3 to rivetedly connect a first blade 6 and a second blade 7. When first handle portion 3 is folded in a counterclockwise manner toward the first plier unit 1, a receiving space 31 can be seen from the second plier unit 2, and can be used to receive the first blade 6 and second blade 7. The first blade 6 and second blade 7 can rotate around the rivet 5 to be unfolded out from the receiving space 31. A third handle portion 8 that drives the second blade 7 to cut is hinged to the non-cutting end of the second blade 7, as are shown in FIGS. 2, 3 and 4. It is noted that the third handle portion 8 can rotate toward the second blade 7 to be folded at an opening of the receiving space 31. It is also noted that the receiving space 31 is large enough to simultaneously receive the first blade 6 and second blade 7, so the size of the blade and handle can be increased to endure a larger force and be able to cut a harder and larger object.

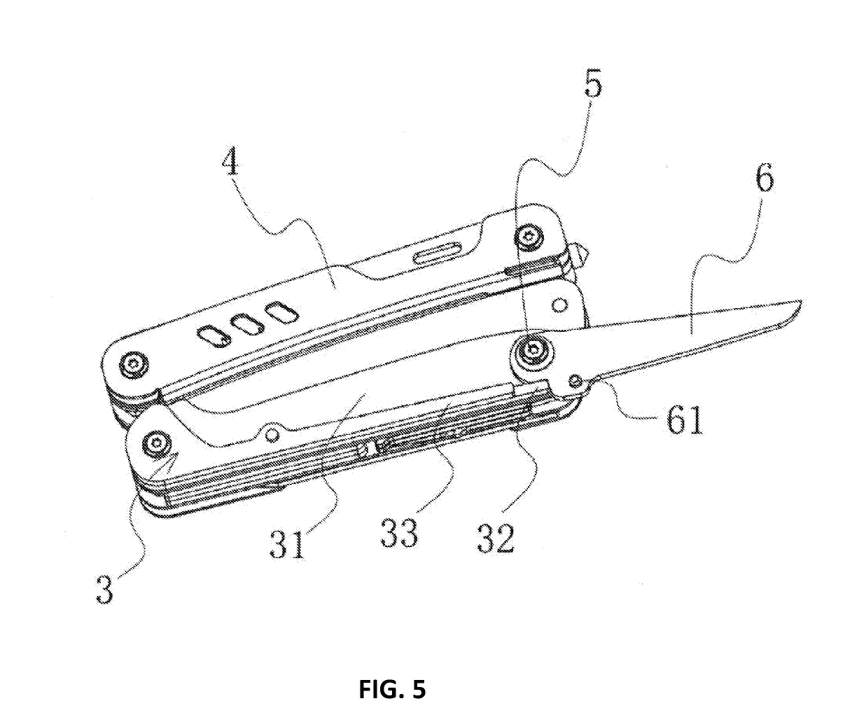

As shown in FIG. 5, the first handle portion 3 has a restricting unit 32 and a spring 33 on the opposite side of the receiving space 31. In one embodiment, the restricting unit 32 is in contact with a stopping edge of the first blade 6 when the first blade 6 rotates to an angle of 180° against the first handle portion 3 to prevent the first blade 6 from further rotating. Without the restricting unit 32 to block the rotation movement of the first blade 6, the rotating angle of the first blade 6 cannot be limited, and a cutting action cannot be completed with the first blade 6 and second blade 7.

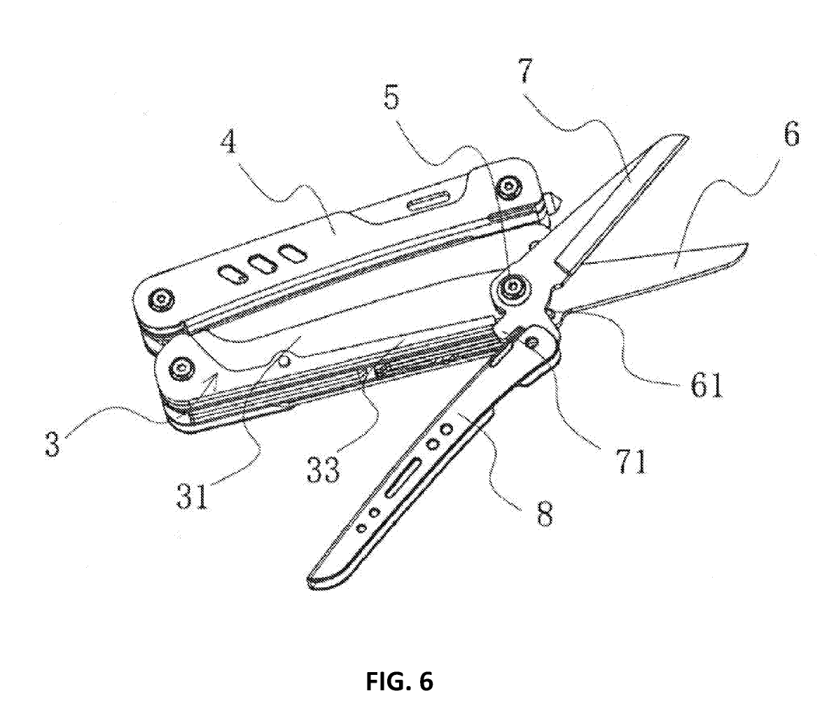

Referring to FIG. 6, the second blade 7 has a pressing position 71 of the spring 33, which can be pressed when second blade 7 rotates to the first blade 6 for cutting. Comparing with a conventional structure with an inner spring when two blades are hinged, this structure can simplify the assembly process of the two blades and reduce the thickness of the blades.

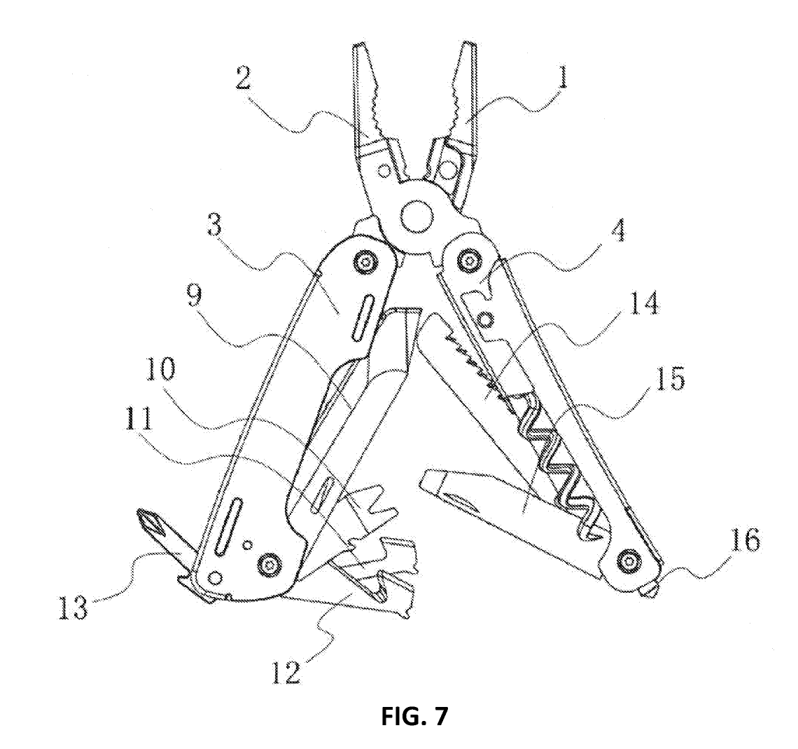

Referring to FIG. 7, a plurality of small tools can be included within the first handle portion 3 and second handle portion 4, riveted to a rear end of each first and second handle portions (3, 4). In one embodiment, small tools riveted to the rear end of first handle portion 3 may include a blade 9, a nail puller 10, a can opener 11, a rope cutter 12 and a screwdriver 13. In another embodiment, small tools riveted to the rear end of second handle portion 4 may include a saw blade 14, a file 15, and a glass knocker 16.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A multifunctional plier comprising a first plier unit with a first handle portion hingedly coupled with a second plier unit with a second handle portion,
wherein the first handle portion has a rivet at a rear end of the first handle portion to rivetedly connect a first blade and a second blade, which are both received within a receiving space, and the first blade and second blade can rotate around the rivet to be unfolded out from the receiving space, wherein the first handle portion has a restricting unit on the opposite side of the receiving space, and the restricting unit is in contact with a stopping edge of the first blade when the first blade rotates to an angle of 180° against the first handle portion to prevent the first blade from further rotating, and a third handle portion that drives the second blade to cut is hinged to the non-cutting end of the second blade and is configured to rotate toward the second blade to be folded at an opening of the receiving space.

2. The multifunctional plier of claim 1, wherein the first handle portion has a spring on the opposite side of the receiving space, and the second blade has a pressing position to press the spring when second blade rotates to the first blade for cutting.

3. The multifunctional plier of claim 1, wherein the first handle portion includes a blade, a nail puller, a can opener, a rope cutter and a screwdriver.

4. The multifunctional plier of claim 1, wherein the second handle portion includes a saw blade, a file, and a glass knocker.

5. The multifunctional plier of claim 2, wherein the first handle portion includes a blade, a nail puller, a can opener, a rope cutter and a screwdriver.

6. The multifunctional plier of claim 2, wherein the second handle portion includes a saw blade, a file, and a glass knocker.
